(19) United States
(12) Patent Application Publication
(10) Pub. No.: US 2007/0200784 A1
(43) Pub. Date: Aug. 30, 2007

(54) Integrated filter in antenna-based detector

(75) Inventors: Jonathan Gorrell, Gainesville, FL (US); Mark Davidson, Florahome, FL (US); Michael E. Maines, Gainesville, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/417,129

(22) Filed: May 4, 2006

Related U.S. Application Data
(60) Provisional application No. 60/777,120, filed on Feb. 28, 2006.

(51) Int. Cl. H01Q 1/52

(52) U.S. Cl. 343/841; 343/700 MS

(57) ABSTRACT

An antenna system includes a dielectric structure formed on a substrate; an antenna, partially within the dielectric structure, and supported by the dielectric structure; a reflective surface formed on the substrate. A shield blocks radiation from a portion of the antenna and from at least some of the dielectric structure. The shield is supported by the dielectric structure.

### CROSS-REFERENCE To RELATED APPLICATIONS

This application is related to and claims priority from the following co-pending U.S. patent application, the entire contents of which is incorporated herein by reference: U.S. Provisional Patent Application No. 60/777,120, titled “Systems and Methods of Utilizing Resonant Structures,” filed Feb. 28, 2006 [Atty. Docket No. 2549-0087].

The present invention is related to the following co-pending U.S. patent applications which are all commonly owned with the present application, the entire contents of each of which are incorporated herein by reference:
(1) U.S. patent application Ser. No. 11/238,991, entitled “Ultra-Small Resonating Charged Particle Beam Modulator,” and filed Sep. 30, 2005;
(2) U.S. patent application Ser. No. 10/917,511, entitled “Patterning Thin Metal Film by Dry Reactive Ion Etching,” filed on Aug. 13, 2004;
(3) U.S. application Ser. No. 11/203,407, entitled “Method Of Patterning Ultra-Small Structures,” filed on Aug. 15, 2005;
(4) U.S. application Ser. No. 11/243,476, entitled “Structures And Methods For Coupling Energy From An Electromagnetic Wave,” filed on Oct. 5, 2005;

(5) U.S. application Ser. No. 11/243,477, entitled “Electron beam induced resonance,” filed on Oct. 5, 2005;
(6) U.S. application Ser. No. 11/325,432, entitled “Resonant Structure-Based Display,” filed on Jan. 5, 2006;
(7) U.S. application Ser. No. 11/410,924 [Atty. Docket No. 2549-0010], entitled “Selectable Frequency EMR Emitter,” filed on Apr. 26, 2006; and
(8) U.S. application Ser. No. 11/400,280 [Atty. Docket No. 2549-0068], entitled “Resonant Detector For Optical Signals,” filed on Apr. 10, 2006.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates to ultra-small devices, and, more particularly, to ultra-small antennas.

### INTRODUCTION & BACKGROUND

Antennas are used for detecting electromagnetic radiation (EMR) of a particular frequency.

As is well known, frequency (f) of a wave has an inverse relationship to wavelength (generally denoted λ). The wavelength is equal to the speed of the wave type divided by the frequency of the wave. When dealing with electromagnetic radiation (EMR) in a vacuum, this speed is the speed of light c in a vacuum. The relationship between the wavelength λ of an electromagnetic wave its frequency f is given by the equation:

$$f = \frac{c}{λ}$$

As shown in FIG. 1, a typical antenna 10 is formed to detect electromagnetic waves having a certain frequency f, with a corresponding wavelength (λₘ). This desired frequency may be referred to herein as the desired detection frequency. The antenna 10 is a so-called quarter wavelength antenna, and its length is a multiple (preferably an odd multiple) of a quarter of the desired detection wavelength, i.e., an odd multiple of ¼ λₘ.

Note that when a electromagnetic wave (W) with wavelength λₘ is incident on the antenna 10, this causes a standing wave (denoted by the dashed line in the drawing) to be formed in the antenna. The standing wave is reflected of the end of the antenna, to form a second standing wave (denoted by the dotted line in the drawing). The wavelength of the standing wave is ½ λₘ.

When an electromagnetic wave travels through a dielectric, the velocity of the wave will be reduced and it will effectively behave as if it had a shorter wavelength. Generally, when an electromagnetic wave enters a medium, its wavelength is reduced (by a factor equal to the refractive index n of the medium) but the frequency of the wave is unchanged. The wavelength of the wave in the medium, λ′ is given by:

$${λ}^{′} = \frac{{λ}_{0}}{n}$$

where λ₀ is the vacuum wavelength of the wave. Note that the antenna 10 shown in FIG. 1 is formed of an homogenous material, typically a metal.

It is desirable to have more selectivity/sensitivity to specific frequencies in antenna detectors.

### BRIEF DESCRIPTION OF THE DRAWINGS

The following description, given with respect to the attached drawings, may be better understood with reference to the non-limiting examples of the drawings, wherein:

FIG. 1 shows various aspects of operation of an antenna;

FIGS. 2-3 are side and top views, respectively, of an antenna with an integrated filter;

FIG. 4 shows various aspects of operation of an antenna; and

FIGS. 5(a)-5(d) show an exemplary process for making an antenna structure.

### THE PRESENTLY PREFERRED EXEMPLARY EMBODIMENTS

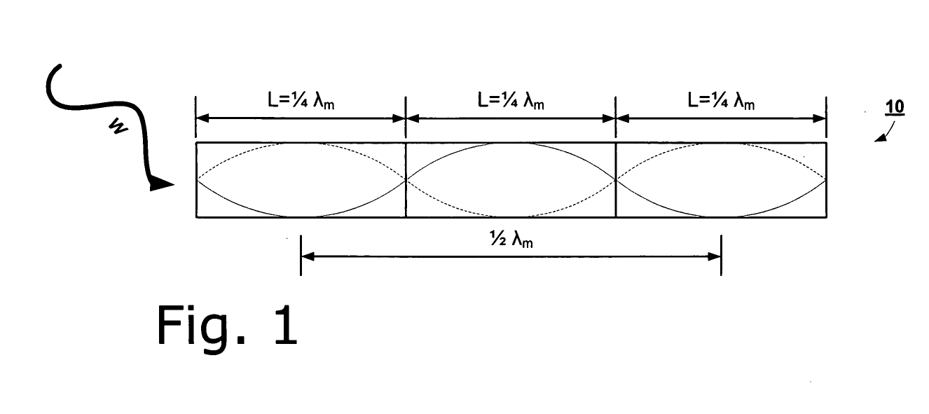

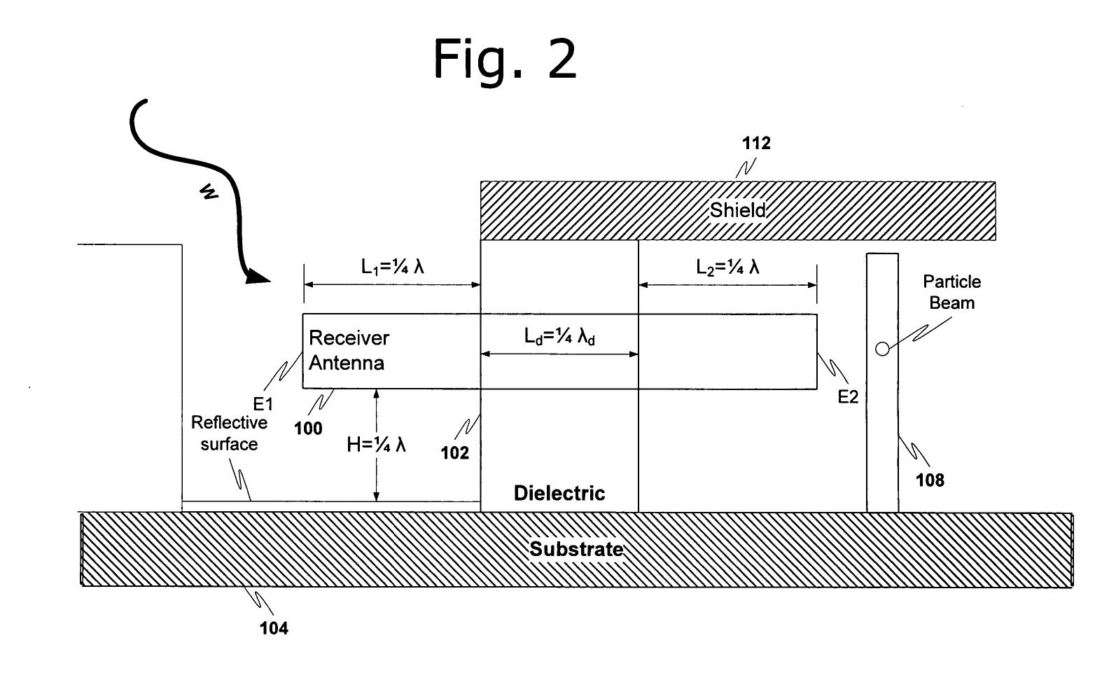

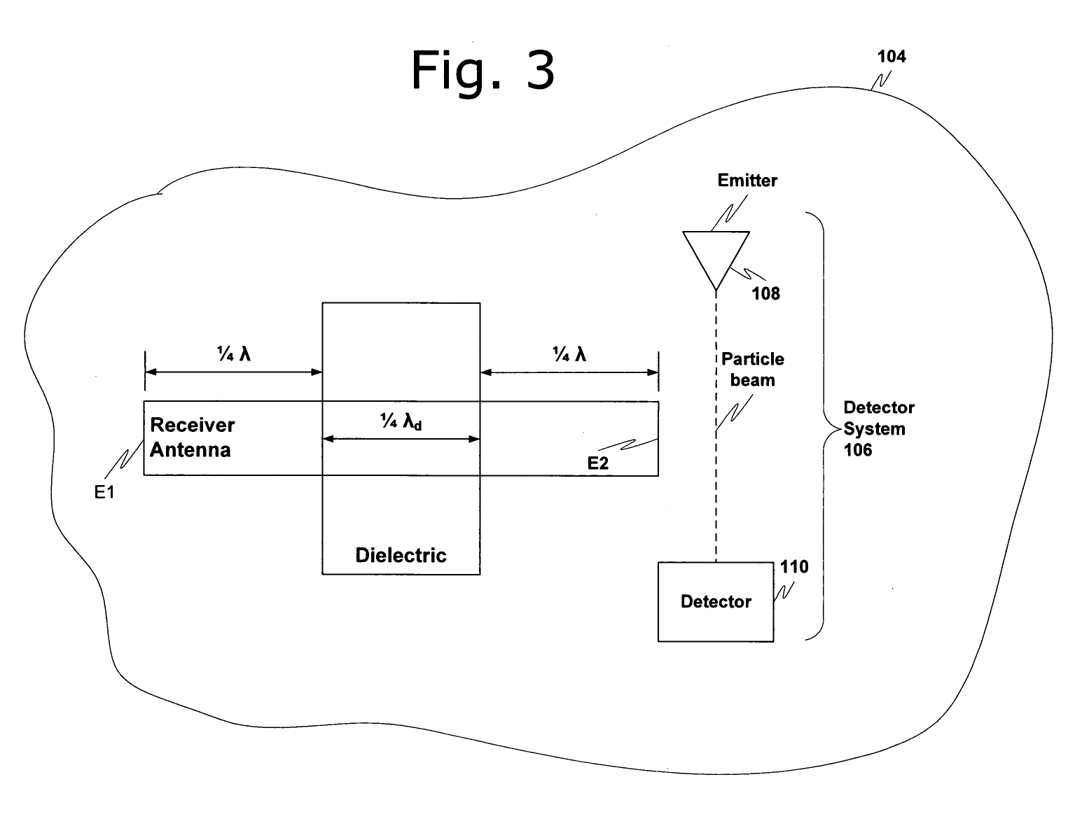

FIGS. 2-3 show a side view and a top view, respectively, of an antenna 100 formed within a dielectric structure 102. The dielectric 102 may be formed on a substrate 104. A detector system 106 is coupled with the antenna. The detector system may comprise an emitter 108 (a source of charged particles) and a detector 110 (not shown in FIG. 1) Various structures for the emitter/detector are disclosed in co-pending U.S. patent application Ser. No. 11/400,280, [Atty. Docket 2549-0068], entitled “Resonant Detector For Optical Signals,” and filed on Apr. 10, 2006, the entire contents of which have been incorporated herein by reference. The detector system may be formed on substrate 104 or elsewhere.

Preferably the detector system 106 is disposed at end E2 of the antenna system.

Although shown as rectangular, the end E2 of the antenna may be pointed to intensify the field.

A shield structure 112 (not shown in FIG. 2) is formed to block EMR from interacting with the detector system 106, in particular, with the particle beam emitted by the emitter 108. The shield 112 may be formed on a top surface of the dielectric structure.

An optional reflective surface 114 may be formed on the substrate 104 to reflect EMR to a receiving end E1 of the antenna 100.

The entire antenna structure, including the detection system, should preferably be provided within a vacuum.

For the purposes of this description, the antenna has three logical portions, namely a first antenna portion (shown in the drawing to the left of the dielectric structure 102), a second antenna portion within the dielectric structure, and a third antenna portion (shown in the drawing to the right of the dielectric structure).

The antenna 100 is formed to detect electromagnetic waves having a certain frequency f, with corresponding wavelength (λ). Accordingly, the length of the first antenna portion, L₁ and that of the third antenna portion L₂ are both ¼λ. The length L_{d} of the second antenna portion, the portion within the dielectric, is ¼λ_{d}, where λ_{d} is the wavelength of the signal within the dielectric 102. The antenna 100 is formed at a height H of ¼ λ above the substrate 104.

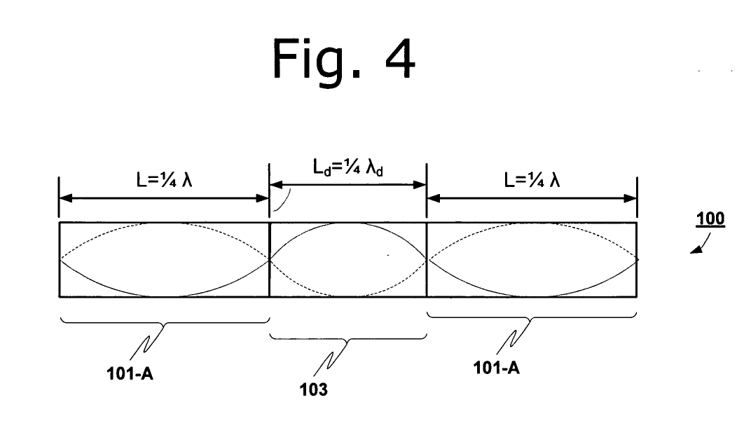

Recall that when an electromagnetic wave travels through a dielectric, its wavelength is reduced but the frequency of the wave is unchanged. The dielectric structure thus acts as a filter for a received signal, allowing EMR of the appropriate wavelength to pass therethrough. FIG. 4 shows the standing wave(s) formed in the antenna 100. As can be seen from the drawing, in the two metal segments 101-A, and 101-B, the wavelength of the standing wave is ¼λ, whereas in the dielectric segment 103, the wavelength of the standing wave is ¼λ_{d}—i.e., the wavelength corresponding to dielectric. The dimensions of the dielectric element can be determined, e.g., based on the relationship between the dielectric constants of the antenna material and the dielectric, e.g., using the following equation:

$$\frac{{l}_{v}}{{l}_{d}} = \sqrt{\frac{{e}_{d} ( {e}_{m} + 1 )}{{e}_{m} + {e}_{d}}}$$

where lᵥ is the length of the metal portion (corresponding to λᵥ, the wavelength of the wave in a vacuum), and l_{d} is the length of the dielectric portion (corresponding to λ_{d} is the wavelength of the wave in the dielectric material); e_{d} is the dielectric constant of the dielectric material and eₘ is the dielectric constant of the metal. Those skilled in the art will understand that lᵥ/l_{d}=λᵥ/λ_{d}).

From this equation, the value of l_{d} can be determined as:

$${l}_{d} = \frac{{l}_{v} \sqrt{{e}_{d} + {e}_{m}}}{\sqrt{{e}_{d} ( {e}_{m} + 1 )}}$$

The dielectric layer acts as a support for the antenna, and a filter.

The antenna structures may be formed of a metal such as silver (Ag).

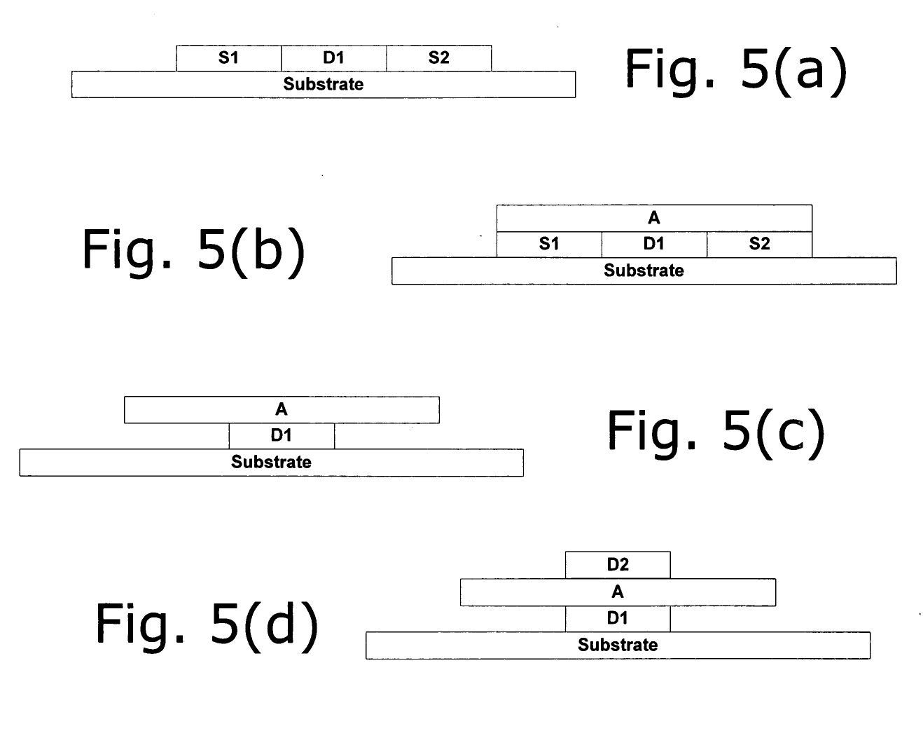

With reference to FIGS. 5(a)-5(d), the antenna structures may be formed as follows (although other methods may be used):

First, the dielectric (D1) is formed on the substrate, along with two sacrificial portions (S1, S2) (FIG. 5(a)). The antenna (A) is then formed on the dielectric (D1) and the two sacrificial portions (S1, S2) (FIG. 5(b)). The sacrificial portions can then be removed (FIG. 5(c)), and then remainder of the dielectric (D2) can be formed on the antenna.

As shown in the drawings, the antenna comprises three portions, namely metal, dielectric, metal. Those skilled in the art will realize, upon reading this description, that the antenna may comprise three metal portions (e.g., in the order metal_{A}, metal_{B}, metal_{A}, where metal_{A} and metal_{B} different metals, e.g., silver and gold). Those skilled in the art will realize, upon reading this description, that the antenna may comprise three dielectric portions (e.g., in the order Dₐ, D_{b}, Dₐ, where Dₐ and D_{b} are different dielectric materials).

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. An antenna system comprising:
a dielectric structure;
an antenna, partially within the dielectric structure, and supported by the dielectric structure; and
a detection system disposed to detect electrical field changes in the antenna.

2. A system as in claim 1 wherein the dielectric structure is formed on a substrate, the system further comprising:
a reflective surface formed on the substrate.

3. A system as in claim 1 further comprising:
a shield blocking radiation from a portion of the antenna.

4. A system as in claim 3 wherein the shield also blocks radiation from the dielectric structure.

5. A system as in claim 3 wherein the shield is supported by the dielectric structure.

6. A system as in claim 1 wherein:
the antenna comprises:
a first metal portion on one side of the dielectric structure;
a middle portion comprising a portion of the dielectric structure; and
a second metal portion on another side of the dielectric structure.

7. A system as in claim 6 wherein the length of the first metal portion is substantially equal to the length of the second metal portion.

8. A system as in claim 7 wherein the length of the dielectric portion of the antenna is based, at least in part, as a function of the dielectric constant of the dielectric material.

9. A system as in claim 1 wherein the detection system includes a source of charged particles.

10. A system as in claim 6 wherein the first metal portion and the second metal portions are comprised of the same metal.

11. A system as in claim 6 wherein the first metal portion and the second metal portions are comprised of different metals.

12. An antenna system comprising:
a dielectric structure formed on a substrate;
an antenna, partially within the dielectric structure, and supported by the dielectric structure;
a reflective surface formed on the substrate;
a shield blocking radiation from a portion of the antenna and from at least some of the dielectric structure, the shield being supported by the dielectric structure; and
a detection system disposed to detect electrical field changes in the antenna, wherein the detection system includes a source of charged particles.

13. An antenna comprising:
a dielectric portion;
a first metal portion on a first side of the dielectric portion; and
a second metal portion on a second side of the dielectric portion.

14. An antenna as in claim 13 wherein the antenna is constructed and adapted to detect electromagnetic waves having a particular frequency, and wherein
a first length of the first metal portion and a second length of the second metal portion and a third length, of the dielectric portion, are each based, at least in part, on a function of the particular frequency.

15. An antenna as in claim 13 wherein the first length is substantially the same as the second length.

16. An antenna as in claim 13 wherein the first metal portion and the second metal portion are comprised of the same metal.

17. An antenna system comprising:
a first antenna portion;
a second antenna portion on a first side of the first antenna portion; and
a third antenna portion on a second side of the first antenna portion.
a shield blocking radiation from at least a part of the antenna; and
a detection system disposed to detect electrical field changes in the antenna, wherein the detection system includes a source of charged particles.

18. An antenna system as in claim 17 wherein:
the first antenna portion and the third antenna portion comprise a first metal; and
the second antenna portion comprises a second metal.

19. An antenna system as in claim 17 wherein:
the first antenna portion and the third antenna portion comprise a first dielectric material; and
the second antenna portion comprises a second dielectric material.

20. An antenna system as in claim 17 wherein:
the first antenna portion and the third antenna portion comprise a metal; and
the second antenna portion comprises a dielectric material.
